(19) United States
(12) Patent Application Publication
(10) Pub. No.: US 2026/0044387 A1
(43) Pub. Date: Feb. 12, 2026

(54) DYNAMIC LOAD BALANCING FOR VIRTUAL MACHINE POWER MANAGEMENT

(71) Applicant: NVIDIA Corporation, Santa Clara, CA (US)

(72) Inventors: Kutty BANERJEE, San Jose, CA (US); Mithun MARAGIRI, San Jose, CA (US); Kechen LU, Sunnyvale, CA (US); Amit PARIKH, Santa Clara, CA (US)

(73) Assignee: NVIDIA Corporation, Santa Clara, CA (US)

(21) Appl. No.: 18/796,702

(22) Filed: Aug. 7, 2024

(51) Int. Cl. G06F 9/50

(52) U.S. Cl. CPC G06F 9/5077; G06F 9/5094

(57) ABSTRACT

One or more processors includes one more circuits. The one or more circuits detect, using a guest operating system (OS) of a virtual machine (VM), a condition of a workload of the VM being executed on a central processing unit (CPU) and on a graphics processing unit (GPU) through the VM, the condition indicative of operation of one of the CPU or the GPU being different than a target level of operation, the target level based on at least one of (i) a characteristic of the workload or (ii) operation of the other of the CPU or the GPU. The one or more circuits provide, to a host OS, based at least on the condition, an instruction to reduce operation of the one of the CPU or the GPU.

### BACKGROUND

A virtual machine (VM) operates on a host, which can provide resources such as Central Processing Unit (CPU), Graphics Processing Unit (GPU), memory, etc. The host can control resources (e.g., power, CPU, GPU, etc.) provided to the VM. This can allow for a level of abstraction of the resources of the host with respect to applications that are executed by the VM, including applications that may use both the CPU and GPU to complete tasks. However, this abstraction may result in resources being directed towards use by various applications and/or VMs in a manner that can have inefficiencies, including with respect to power usage.

### SUMMARY

Implementations of the present disclosure relate to dynamic load balancing, such as for power management of VMs. In contrast to conventional systems, such as those described above, systems and methods in accordance with the present disclosure can allow for power management for VMs, including power management that responds to dynamic workload conditions. For example, systems and methods in accordance with the present disclosure can detect a condition of a workload of a VM and can provide, to a host OS, an instruction to reduce operation of one of a CPU or a GPU on which the VM is being executed (e.g., based on the detected condition). This can allow the system to allocate CPU and/or GPU resource usage in a manner more closely aligned with demands of the workload, which can allow for more effective power management, such as by reducing periods in which the CPU and/or GPU are being operated at a higher level than needed to a given performance or time to completion of tasks.

At least one aspect relates to one or more processors including one or more circuits. The one or more circuits are to detect, using a guest operating system (OS) of a virtual machine (VM), a condition of a workload of the VM being executed on processing units including a central processing unit (CPU) and a graphics processing unit (GPU). The condition may be indicative of operation of the processing units being different than a target level of operation, and the target level may be based on at least one of (i) a characteristic of the workload or (ii) operation of another of the processing units. The one or more circuits are to provide, to a host OS, based at least on the condition, an instruction to reduce operation of the one of the processing units. The one or more circuits are to modify, by the host OS, behavior of the processing units based on the instruction.

In some implementations, the one or more circuits are to execute the VM, and the VM is configured to cause the CPU and the GPU to execute the workload. In some implementations, the one or more circuits are to detect the condition based at least on one of: i) a load of the GPU, ii) an occupancy of a queue of the GPU, or iii) a resolution characteristic. In some implementations, the one or more circuits are to communicate the instruction to the host OS using a channel from a guest OS to the host OS.

In some implementations, one or more characteristics of the workload used to detect the condition are not provided to the host OS. In some implementations, the one or more circuits are to detect the condition by evaluating a characteristic of at least one of the workload, the operation of the CPU, or the operation of the GPU, using one or more rules, policies, or heuristics. In some implementations, the workload is a real-time workload of the VM.

At least one aspect relates to a system. The system includes one or more processing units, and one or more memory units storing instructions that, when executed by the one or more processing units, cause the one or more processing units to execute operations. The operations can include detecting, using a guest operating system (OS) of a virtual machine (VM), a condition of a workload of the VM being executed on a central processing unit (CPU) and on a graphics processing unit (GPU) through the VM. The condition can be indicative of operation of one of the CPU or the GPU being different than a target level of operation, and the target level can be based on at least one of (i) a characteristic of the workload or (ii) operation of the other of the CPU or the GPU. The operations can include providing, to a host OS, based at least on the condition, an instruction to reduce operation of the one of the CPU or the GPU. The operations can include modifying, by the host OS, behavior of the one or more processing units based on the instruction.

In some implementations, the operations further include executing the VM. The VM is configured to cause the CPU and the GPU to execute the workload. In some implementations, the operations further include detecting the condition based at least on one of: i) a load of the GPU, ii) an occupancy of a queue of the GPU, or iii) a resolution characteristic. In some implementations, the operations further include communicating the instruction to the host OS using a channel from a guest OS to the host OS.

In some implementations, one or more characteristics of the workload used to detect the condition are not provided to the host OS. In some implementations, the operations further include detecting the condition by evaluating a characteristic of at least one of the workload, the operation of the CPU, or the operation of the GPU, using one or more rules, policies, or heuristics. In some implementations, the workload is a real-time workload of the VM.

At least one aspect relates to a method. The method includes detecting, using a guest operating system (OS) of a virtual machine (VM), a condition of a workload of the VM being executed on processing units including a central processing unit (CPU) and a graphics processing unit (GPU). The condition may be indicative of operation of one of the processing units being different than a target level of operation, and the target level may be based on at least one of (i) a characteristic of the workload or (ii) operation of another of the processing units. The method can include providing, to a host OS, based at least on the condition, an instruction to reduce operation of the one of the processing units. The method can include modifying, by the host OS, behavior of the processing units based on the instruction.

In some implementations, the method further includes executing the VM, and the VM is configured to cause the CPU and the GPU to execute the workload. In some implementations, the method further includes detecting the condition based at least on one of: i) a load of the GPU, ii) an occupancy of a queue of the GPU, or iii) a resolution characteristic. In some implementations, the method further includes communicating the instruction to the host OS using a channel from a guest OS to the host OS.

In some implementations, one or more characteristics of the workload used to detect the condition are not provided to the host OS. In some implementations, the method further includes detecting the condition by evaluating a characteristic of at least one of the workload, the operation of the CPU, or the operation of the GPU, using one or more rules, policies, or heuristics. In some implementations, the workload is a real-time workload of the VM.

The one or more processors, systems, and/or methods described herein can be implemented by or included in at least one of a system incorporating one or more VMs; a system for performing simulation operations; a system for performing light transport simulation; a system implemented using an edge device; a system implemented using a robot; a system for performing collaborative content creation for 3D assets; a system including one or more large language models (LLMs); a control system for an autonomous or semi-autonomous machine; a perception system for an autonomous or semi-autonomous machine; a system for generating synthetic data; a system for performing digital twin operations; a system for performing conversational AI operations; a system for performing deep learning operations; a system implemented at least partially in a data center; or a system implemented at least partially using cloud computing resources.

### BRIEF DESCRIPTION OF THE DRAWINGS

The present systems and methods for dynamic load balancing for virtual machine power management are described in detail below with reference to the attached drawing figures, wherein:

FIG. 1 is a block diagram of an example system for dynamic load balancing, in accordance with some implementations of the present disclosure;

FIG. 2 is a block diagram of an example system for dynamic load balancing, in accordance with some implementations of the present disclosure;

FIG. 3 is a block diagram of an example system for dynamic load balancing, in accordance with some implementations of the present disclosure;

FIG. 4 is a flow diagram of an example of a method for dynamic load balancing, in accordance with some implementations of the present disclosure;

FIG. 5 is a block diagram of an example content streaming system suitable for use in implementing some implementations of the present disclosure;

FIG. 6 is a block diagram of an example computing device suitable for use in implementing some implementations of the present disclosure; and

FIG. 7 is a block diagram of an example data center suitable for use in implementing some implementations of the present disclosure.

### DETAILED DESCRIPTION

This disclosure relates to systems and methods for dynamic load balancing to achieve virtual machine-based power management. Power management can be challenging for virtual machines due to various factors. For example, a guest operating system (OS) for the virtual machine may not have direct control of CPU power usage. The host OS may not have visibility into the workload of the guest operating system. While techniques are available for operations such as boosting power based on workload in some systems (e.g., bare metal systems), such techniques cannot address complexities of virtual machine power management.

Systems and methods in accordance with the present disclosure can allow for power management for virtual machines, including power management that responds to dynamic workload conditions. This can be useful in implementations including where the virtual machine uses both CPU and GPU hardware to execute the workload. The guest OS can evaluate the workload to determine a condition of the workload, such as whether the workload is GPU limited, CPU limited, or of resolution that is less than a threshold or a resolution change (e.g., from a typical resolution to a low resolution). Based on the determined condition, the guest OS can output a signal indicating instructions to modify at least one of i) a parameter of the CPU or ii) a parameter of the GPU. For example, the guest OS can indicate/provide/send instructions to lower a clock cap of the CPU responsive to the condition being GPU limited (e.g., to allow for less power usage by the CPU while the CPU is waiting for GPU operations to be completed). The guest OS can indicate instructions to lower a power cap of the GPU responsive to the condition being CPU limited (e.g., to allow for less GPU power while the GPU is waiting for CPU operations to be completed) and/or the condition being a low resolution workload. The guest OS can periodically evaluate the condition of the workload to allow for dynamic power management.

The host OS can receive the instructions and control operation of at least one of the GPU or the CPU according to the instructions, such as to lower the CPU clock cap or the GPU power cap according to the instructions. The host OS can receive the instructions by way of a communication channel between the guest OS and the host OS, such as a communication channel associated with a daemon process, a socket (e.g., virtio socket), or a custom trap in a hypervisor. Systems and methods in accordance with the present disclosure can perform such power management operations in real-time with the workload, rather than statically (e.g., based on an identifier of the workload, rather than an actual real-time resource usage of the workload) or based on cadence.

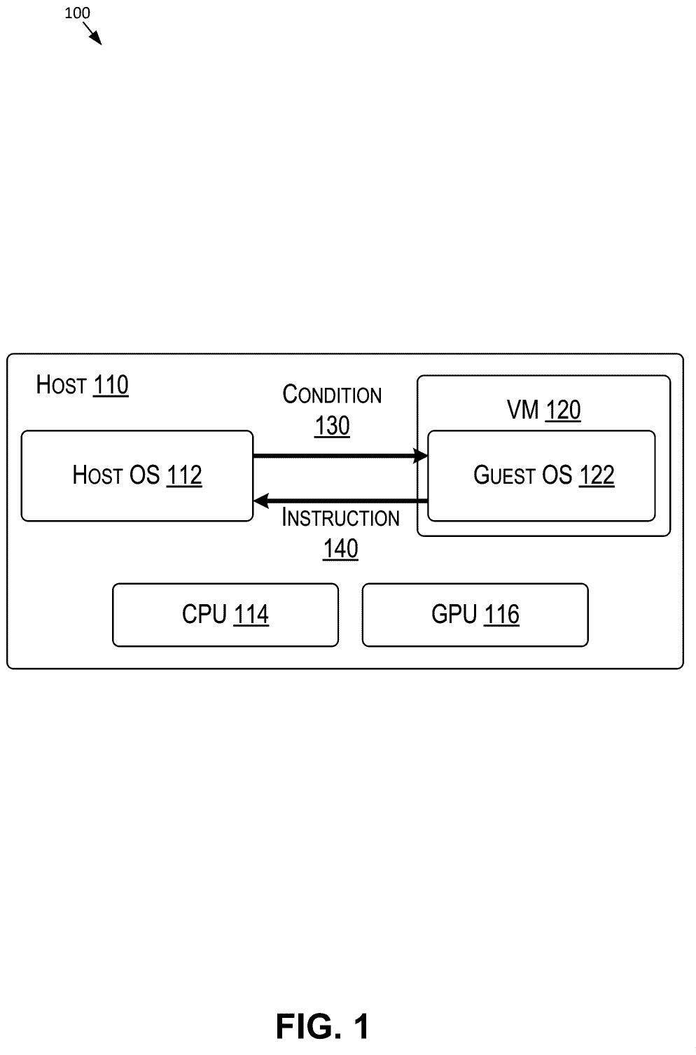

With reference to FIG. 1, FIG. 1 is an example computing environment including a system 100 for dynamic load balancing, in accordance with some implementations of the present disclosure. The system 100 can include a host 110. The host 110 can include one or more of a host operating system (OS) 112, a CPU 114, a GPU 116, and a virtual machine (VM) 120. The VM 120 can include a guest OS 122. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors executing instructions stored in memory. The system 100 can include any function, model (e.g., machine learning model), operation, routine, logic, or instructions to perform functions as described herein.

The host 110 can be or include a physical machine or server that provides the hardware resources, such as the CPU 114 and GPU 116, for executing computational tasks. The host 110 can operate as the foundational platform for running the VM 120. The host OS 112 of the host 110 can manage the hardware resources of the host 110 (e.g., the CPU 114, GPU 116, etc.) and provide an environment for executing applications and managing the VM 120.

The host 110 can leverage the processing power of the CPU 114 and/or the GPU 116 to perform computing tasks. For example, the CPU 114 can execute instructions from the host OS 112 and other applications, handling various computational workloads. In some implementations, the host 110 can utilize the GPU 116 for tasks that require parallel processing capabilities. The GPU 116 can accelerate the rendering of images, videos, etc., for such applications as graphics rendering, machine learning, etc. In some implementations, the host 110 can allocate processing power of the CPU 114 and/or the GPU 116 to the VM 120. The processing power of the CPU 114 and/or the GPU 116 allocated to the VM 120 can be used for the workload of the VM 120.

The host 110 can include a mechanism for monitoring and/or managing the performance of the VM 120. For example, the host 110 can include management techniques (e.g., power management techniques to control the power of the VM 120, etc.). In some implementations, the host OS 112 can collect and analyze performance metrics, such as CPU and GPU usage, to operate the VM 120. In some implementations, the host 110 can determine when the power management techniques should be implemented (e.g., based on a condition 130 as discussed below).

The VM 120 can be or include an environment for various applications to emulate a physical computer within the host 110. The VM 120 can include a guest OS 122. The guest OS 122, which is separate from the host OS 112, can manage the resources of the VM 120 (e.g., the CPU 114, GPU 116, etc. allocated to the VM 120). The guest OS 122 can execute the applications within the environment based on the resources allocated to the VM 120.

In some implementations, the VM 120 can function independently of the host OS 112. In some implementations, the guest OS 122 can run inside the VM 120, operating as if the guest OS 122 is on a physical machine, managing its own applications and resources. In some implementations, the VM 120 can be configured to cause the CPU 114 and the GPU 116 that are provided by the host 110 to execute a workload for running the applications. In some implementations, the VM 120 can include multiple VMs 120 each of which operates as an environment. Each VM 120 can run its own guest OS 122 to emulate a physical computer within the host 110 and communicating with the host 110.

The VM 120 communicates the condition 130 and instruction 140 with the host OS 112. As shown, the VM 120 can detect the condition 130 to the host OS 112. In some implementations, the guest OS 122 can detect the condition 130 to indicate that the power management techniques should be implemented. The condition 130 can be or include a characteristic of the workload of the VM 120 being executed on processing units (e.g., the CPU 114 and/or on GPU 116) allocated to the VM 120. For example, the condition 130 can reflect whether the GPU 116 and/or CPU 114 are operating at a higher level (or at a lower level) than they should be for the given workload. In some implementations, the condition 130 can indicate that operation of one of the processing units (e.g., the CPU 114, the GPU 116, etc.) is different than a target level of operation. The detected condition 130 can thereby reflect whether the one of the processing units (e.g., the GPU 116, the CPU 114, etc.) is operating at a suitable level. For example, the condition 130 can indicate that the operation is at a higher or lower level compared with the target level of operation. In some implementations, the target level for operation of the one of the processing units (e.g., the CPU 114, the GPU 116, etc.) can be based on at least one of (i) a characteristic of the workload or (ii) operation of another of the processing units (e.g., the CPU 114 or the GPU 116).

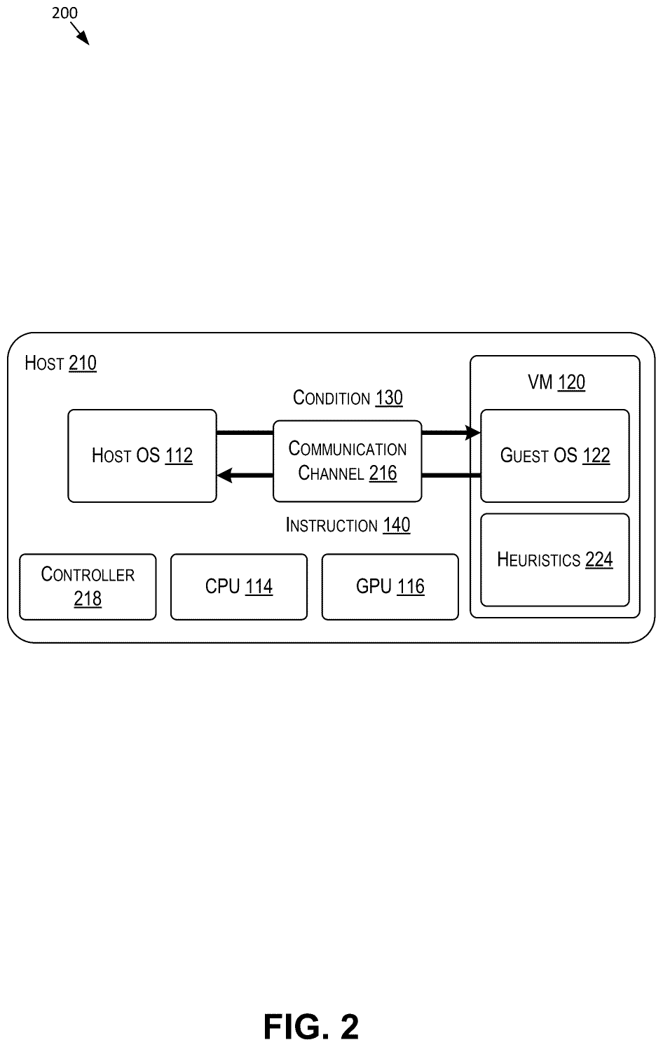

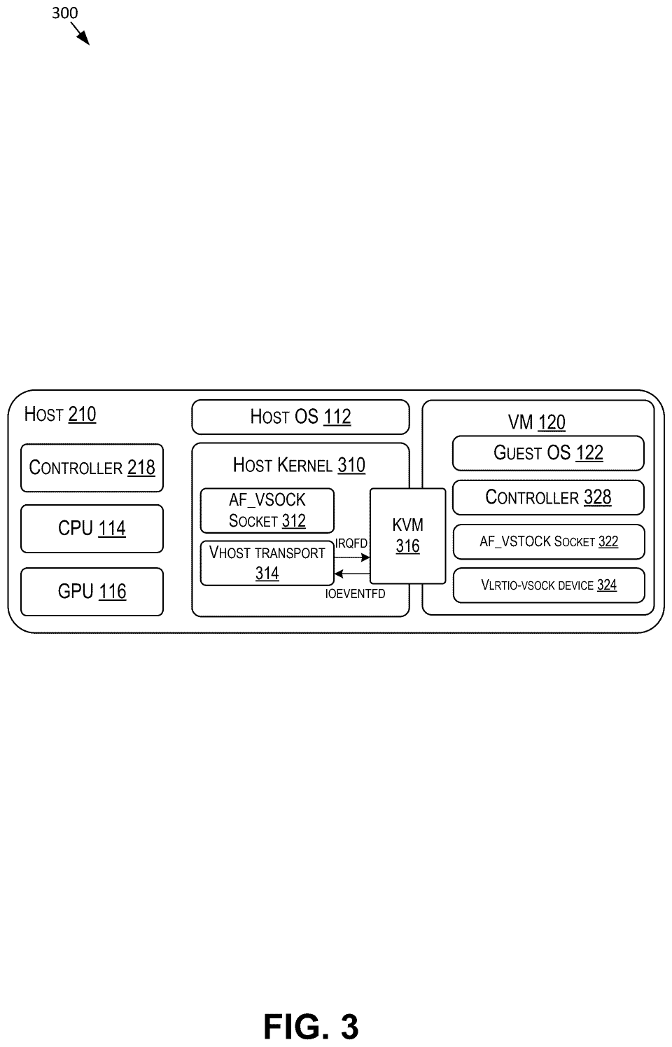

In some implementations, the condition 130 can reflect whether the GPU 116 and/or CPU 114 are operating at a different condition (e.g., GPU limited, CPU limited, etc.) than they should be for the given workload and/or given operating condition. In some implementations, the workload can be a real-time workload (e.g., such as to monitor the dynamic workload) being executed on both the CPU 114 and the GPU 116. In some implementations, the guest OS 122 can interact with the host OS 112 through virtualized hardware interfaces (e.g., as discussed with respect to FIG. 2, FIG. 3, etc.).

In some implementations, the condition 130 can indicate that the operation is at a higher level of resources compared with the target level, for example, if the workload is lower resolution (e.g., lower than the workload that the provided level of resources can address). In some implementations, the condition 130 can indicate that the operation is at a lower level compared with the target level, such as to trigger lowering of clocks. In some implementations, the guest OS 122 can be configured to detect the condition 130 based at least on one of: i) the load of the GPU 116, ii) an occupancy of a queue of the GPU 116, or iii) a resolution characteristic of the workload. For example, the guest OS 122 can evaluate the workload to determine whether the workload is GPU limited, CPU limited, or of a resolution change (e.g., a low resolution). In some implementations, the guest OS 122 can be configured to detect the condition 130 regarding one of the processing units (e.g., the CPU 114, the GPU 116, etc.) based at least on a characteristic of another of the processing units (e.g., the CPU 114, the GPU 116, etc.). The characteristic can be or include the load, the occupancy of a queue, etc. In some implementations, the guest OS 122 can be configured to detect a real-time status of the condition 130. For example, the condition 130 can be or include the characteristic of the workload of the VM 120 being currently executed on the CPU 114 and/or on GPU 116 allocated to the VM 120.

In some implementations, the guest OS 122 can be configured to detect the condition 130 by evaluating a characteristic of at least one of the workload, the operation of the CPU 114, and/or the operation of the GPU 116, using one or more rules, policies, or heuristics (e.g., as discussed with respect to FIG. 2).

The guest OS 122 can provide the instruction 140 to the host OS 112 based at least in part on the condition 130. For example, based on the condition 130, the guest OS 122 can output a signal indicating the instruction 140. The host OS 112 can modify behavior of the processing units (e.g., the CPU 114, the GPU 116, etc.) based on the instruction 140. In some implementations, the instruction 140 can be to modify one of i) a parameter of the GPU 116, or ii) a parameter of the CPU 114. The host OS 112 can modify the one of i) a parameter of the GPU 116 or ii) a parameter of the CPU 114. In some implementations, the instruction 140 is to reduce operation (e.g., a clock cap, a power cap, etc. of the CPU 114 and/or the GPU 116) of one of the CPU 114 or the GPU 116. For example, the host OS 112 can reduce, based on the instruction 140, the operation of the CPU 114 or the GPU 116, when the instruction 140 indicates that the operation of the CPU 114 or the GPU 116 should be reduced. In some implementations, the instruction 140 is to reduce operation of both the CPU 114 and the GPU 116. The host OS 112 can reduce operation of both the CPU 114 and the GPU 116. In some implementations, the instruction 140 can be to lower a clock cap of the CPU 114 responsive to the condition 113 being GPU limited (e.g., to allow for less power usage by the CPU 114 while the CPU 114 is waiting for GPU operations to be completed). Then, the host OS 112 can lower a clock cap of the CPU 114 responsive to the condition 113 being GPU limited. In some implementations, the instruction 140 can be to lower a power cap of the GPU 116 responsive to the condition 130 being CPU limited (e.g., to allow for less GPU power while the GPU 116 is waiting for CPU operations to be completed) and/or the condition 130 being a low resolution workload. Then, the host OS 112 can lower a power cap of the GPU 116 responsive to the condition 130 being CPU limited. In some implementations, the guest OS 122 can periodically evaluate the condition 130 of the workload to allow for dynamic power management. This allows for real-time power management.

In some implementations, the instruction 140 does not include a characteristic of the workload used to detect the condition 130. That is, the guest OS 122 can determine to not include the characteristic in the instruction 140 and/or can be prevented from providing such characteristic of the workload to the host OS 112. This can improve the host-VM communication, such as reduce complexity of the communication between the host OS 112 and the guest OS 122.

In some implementations, the guest OS 122 and the host OS 112 can communicate the instruction 140 using a channel between the guest OS 122 and the host OS 112. For example, the guest OS 122 can provide the instruction 140 through a channel from the guest OS 122 to the host OS 112, as discussed below with respect to FIG. 2.

FIG. 2 is an example computing environment including a system 200 for dynamic load balancing, in accordance with some implementations of the present disclosure. More specifically, in the system 200, as opposed to the host 110 shown in FIG. 1, a host 210 additionally includes a controller 218, communication channel 216, and heuristics 224 of the VM 120. The description and figures are non-limiting examples.

In some implementations, the guest OS 122 can interact with the host OS 112 through the communication channel 216. As shown, the VM 120 communicates the condition 130 and the instruction 140 with the host OS 112 through the communication channel 216.

In some implementations, the guest OS 122 can be configured to detect the condition 130 by evaluating a characteristic using one or more rules, policies, or heuristics 224. In some implementations, the guest OS 122 can detect the condition 130 based on telemetry data. For example, the guest OS 122 can receive the telemetry data including the characteristic and then detect the condition 130 based on the telemetry data. In some examples, the condition 130 can include telemetry data, such as User-Mode driver telemetry (UMD) information, Kernel-mode driver (KMD) telemetry information, GPU queue occupancy, GPU utilization, etc. In some implementations, the guest OS 122 can receive the condition 130 including the telemetry data associated with an application workload running on foreground.

In some implementations, the guest OS 122 can use the heuristics 224 to collect and/or analyze the telemetry information in the condition 130. The guest OS 122 can analyze the workload of the GPU 116 (e.g., queue occupancy, etc.), and can provide the instruction 140 as needed. For example, based on the telemetry data analyzed using the heuristics 224, the guest OS 122 can determine whether to provide the instruction 140 (e.g., to indicate that the workload of the GPU 116 should be changed). In some implementations, the guest OS 122 does not perform any operation when the analyzed telemetry data meets a predetermined condition (e.g., the operation of the CPU 114 or the GPU 116 is within the target level of operation). In some implementations, the guest OS 122 can provide, to the host OS 112, the instruction 140 indicating that the operation of the CPU 114 or the GPU 116 should be adjusted when the analyzed telemetry data meets a predetermined condition (e.g., the operation of the CPU 114 or the GPU 116 is different than the target level of operation). The guest OS 122 can provide (e.g., through the instruction 140) a specific change, for example, “low load,” “medium load,” “high load,”“full load,”or otherwise any specified load.

As discussed above, the instruction 140 can be to modify one of i) a parameter of the GPU 116, or ii) a parameter of the CPU 114. In some implementations, the instruction 140 is to reduce operation of one of the CPU 114 or the GPU 116. In some implementations, the instruction 140 is to reduce operation of both the CPU 114 and the GPU 116. In some implementations, the instruction 140 can be to lower a clock cap of the CPU 114 responsive to the condition 113 being GPU limited (e.g., to allow for less power usage by the CPU 114 while the CPU 114 is waiting for GPU operations to be completed). In some implementations, the instruction 140 can be to lower a power cap of the GPU 116 responsive to the condition 130 being CPU limited (e.g., to allow for less GPU power while the GPU 116 is waiting for CPU operations to be completed) and/or the condition 130 being a low resolution workload. In some implementations, the host OS 112 can perform operations indicated in the instruction 140 through the controller 218. For example, based on the instruction 140 from the VM 120, the host OS 112 can instruct the controller 218 (e.g., a clock controller) to lower the clock rate associated with the use of the CPU 114, the GPU 116, etc. In some implementations, the host OS 112 can set, via the controller 218, a new CPU frequency ratio (e.g., scaling factor 100 MHz), a new GPU power cap/clock, etc.

As discussed above, the host OS 112 and the guest OS 122 can communicate with each other through the communication channel 216. The communication channel 216 can be implemented in various manners, as discussed below.

FIG. 3 is an example computing environment including a system 300 for dynamic load balancing, in accordance with some implementations of the present disclosure. More specifically, in the system 300, as opposed to the host 110 shown in FIG. 1, a host 310 additionally includes a controller 218, a host kernel 310 (which includes AF_VSOCK Socket 312, Vhost transport 314, etc.), a controller 328 of the VM 120, AF_VSOCK Socket 322 of the VM 120, and Vlrtio-vsock device 324 of the VM 120. A KVM 316 is shown to connect the host kernel 310 and the VM 120. The description and figures are non-limiting examples.

The host 210 can include the host kernel 310 to manage the resources (e.g., the CPU 114, the GPU 116, etc.) and/or communication with the VM 120. In some implementations, the host kernel 310 can manage the communication with the VM 120 through the Vlrtio-vsock device 324 and Vhost transport 314. In some implementations, the host kernel 310 can manage the data transport (e.g., the condition 130, the instruction 140, etc.) between the VM 120 and the host 210 through Vhost transport 314. Vhost transport 314 can be a data transport layer (e.g., implemented inside the host kernel 310). Vhost transport 314 can follow a specific Vhost protocol to transport data as messages. In some implementations, the VM 120 can communicate with Vhost transport 314 through irqfd and ioeventfd file descriptors. In some implementations, the VM 120 can communicate with Vhost transport 314 through shared virtual queues (e.g., shared memory) set up by the KVM 316. For example, if data or communication request from the VM 120 is available to be read by Vhost transport 314, this can be notified through ioeventfd as an available state. In response to a completion of a communication of the data or communication request, Vhost transport 314 can signal back through irqfd. In some implementations, as shown, Vhost transport 314 can utilize an application interface (e.g., AF_VSOCK Socket 312) to use in the host 210 and/or the VM 120.

In some implementations, the VM 120 can utilize the Vlrtio-vsock device 324 to manage the communication with the host 210. The Vlrtio-vsock device 324 can be a data transport layer (e.g., implemented inside the VM 120). The Vlrtio-vsock device 324 can manage the communication on the VM's side, serving as an emulated device to bridge applications (e.g., including a controller in the VM 120, corresponding to the controller 218). In some implementations, the Vlrtio-vsock device 324 can utilize a KVM framework to register a part of shared virtual queues (e.g., shared memory). The virtio-vsock device 324 and Vhost transport 314 can communicate with each other to manage the communication. In some implementations, data or requests/notifications associated with an event can be communicated between the Vlrtio-vsock device 324 and Vhost transport 314, through irqfd and ioeventfd (e.g., set up by the KVM 316).

In some implementations, the VM 120 can manage the communication with the host 210 (e.g., the host kernel 310) through AF_VSOCK Socket 322. The AF_VSOCK Sockets on both the host kernel 310 and the VM 120 can enable efficient and low-latency communication between the host 210 and the VM 120, for example using shared memory for faster data transfer.

In some implementations, as discussed herein, the KVM 316 can communicate data (e.g., irqfd, ioeventfd, etc.) and/or resources (e.g., CPU 114, GPU 116, etc.) with Vhost transport 314. The KVM 316 can control flow and/or setup of the communication channel. In some implementations, the KVM 316 can be configured to create, run, pause, terminate, etc. the VM 120, while managing the data and resources. In some implementations, the KVM 316 can dynamically allocate physical resources (e.g., the CPU 114, the GPU 116, etc.) to the VM 120, based on the condition 130 and/or the instruction 140.

As shown, the VM 120 can send ioeventfd, through the KVM 316, to the host kernel 310. In some implementations, the VM 120 can send ioeventfd through the instruction 140. For example, the VM 120 can notify (e.g., along with the instruction 140) the host 210 when the VM 120 performs specific operations that requires the host's attention. The host kernel 310 can send irqfd, through the KVM 316, to the VM 120. In some implementations, the host 210 can change a parameter of the CPU 114 or the GPU 116 provided to the VM 120, based on irqfd.

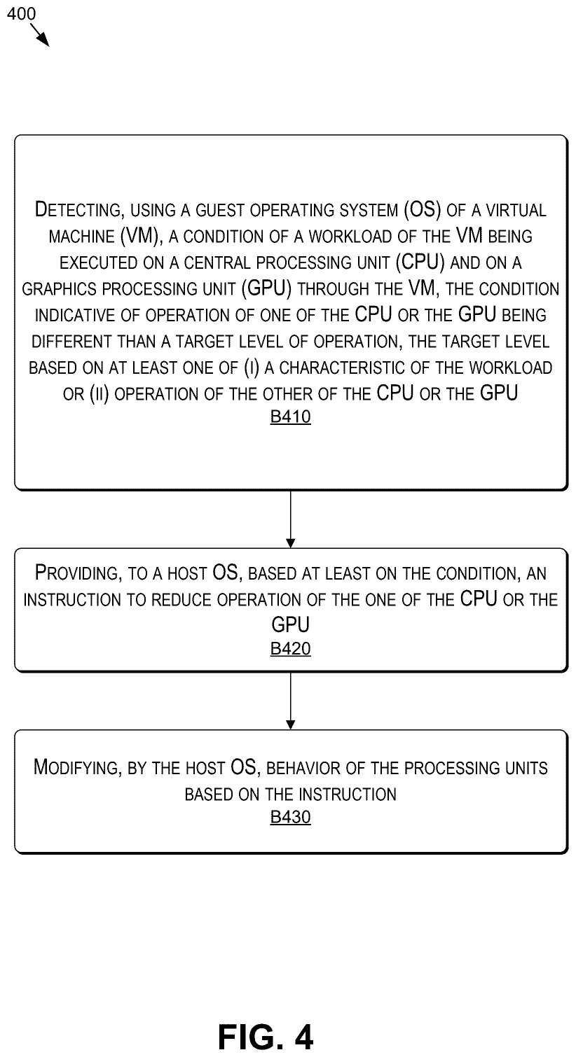

FIG. 4 is a flow diagram showing a method 400 for dynamic load balancing, in accordance with some implementations of the present disclosure. Various operations of the method 400 can be implemented by the same or different devices or entities at various points in time. For example, one or more first devices may implement operations relating to detecting conditions, one or more second devices may implement operations relating to providing instructions, etc. to the one or more first devices.

In a brief overview, the method 400, at block B410, includes detecting, using a guest operating system (OS) of a virtual machine (VM), a condition of a workload of the VM being executed on processing units including a central processing unit (CPU) and a graphics processing unit (GPU). The condition can be indicative of operation of one of the processing units (e.g., the CPU or the GPU) being different than a target level of operation. The target level can be based on at least one of (i) a characteristic of the workload or (ii) operation of another of the processing units (e.g., the CPU or the GPU). The method 400, at block B420, can include providing, to a host OS, based at least on the condition, an instruction to reduce operation of the one of the CPU or the GPU. The method 400, at block B430, can include modifying, by the host OS, behavior of the processing units based on the instruction.

At block B410, the guest OS (e.g., the guest OS 122) can detect the condition (e.g., the condition 130). In some implementations, the method 400 can include, at block B410, the guest OS detecting the condition indicating that the power management technique should be implemented. For example, the guest OS can detect the condition in response to operation of one of the CPU (e.g., the CPU 114) or the GPU (e.g., the GPU 116) being different than a target level of operation. In some implementations, the target level for the operation of one of the CPU or the GPU can be based on at least one of (i) a characteristic of the workload or (ii) operation of the other of the CPU or the GPU. In some implementations, the method 400 can include the guest OS detecting the condition that reflects whether the GPU and/or CPU are operating at a different condition (e.g., GPU limited, CPU limited, etc.) than they should be for the given workload and/or given operating condition. For example, the condition can indicate that the operation is at a higher level of resources compared with the target level (e.g., when the workload is lower resolution, such as lower than the workload that the provided level of resources can address). The condition can indicate that the operation is at a lower level compared with the target level, such as to trigger lowering of clocks. In some implementations, the method 400 can include the guest OS detecting the condition based on a real-time workload (e.g., such as to monitor the dynamic workload) being executed on the CPU or the GPU.

In some implementations, the method 400 can include, at block B410, the guest OS detecting the condition by performing heuristics-driven decision on how to manage the power. For example, the guest OS can evaluate a characteristic of at least one of the workload, the operation of the CPU, or the operation of the GPU, using one or more rules, policies, or heuristics.

At block B420, the guest OS can provide, to a host OS (e.g., the host OS 112), an instruction (e.g., the instruction 140) to reduce operation of the one of the CPU or the GPU. In some implementations, the method 400 can include, at block B420, the guest OS providing the instruction based at least in part on the condition. In some implementations, the guest OS can provide the instruction through a channel (e.g., the communication channel 216) from the guest OS to the host OS. The instruction can be to modify one of i) a parameter of the GPU, or ii) a parameter of the CPU. For example, the guest OS can provide the instruction to reduce operation (e.g., a clock cap, a power cap, etc. of the CPU and/or the GPU) of one of the CPU or the GPU. In some implementations, the host OS can reduce, based on the instruction, the operation of the CPU or the GPU. For example, the host OS can reduce the operation of the CPU or the GPU, in response to the instruction indicating that the operation of the CPU or the GPU should be reduced. In some implementations, the method 400 can include, at block B420, the guest OS periodically evaluating the condition. The guest OS can provide the instruction based on the evaluated condition.

At block B430, the host OS can modify behavior of the processing units based on the instruction. In some implementations, the host OS can modify one of i) a parameter of the GPU 116, or ii) a parameter of the CPU 114. In some implementations, the host OS can reduce operation (e.g., a clock cap, a power cap, etc. of the CPU and/or the GPU) of one of the processing units (e.g., the CPU or the GPU). For example, the host OS can reduce, based on the instruction, the operation of the CPU or the GPU, when the instruction indicates that the operation of the CPU or the GPU should be reduced. In some implementations, the host OS can reduce operation of both the CPU and the GPU. In some implementations, the host OS can lower a clock cap of the CPU responsive to the condition being GPU limited (e.g., to allow for less power usage by the CPU while the CPU is waiting for GPU operations to be completed). In some implementations, the host OS can lower a power cap of the GPU responsive to the condition being CPU limited (e.g., to allow for less GPU power while the GPU is waiting for CPU operations to be completed) and/or the condition being a low resolution workload. In some implementations,

### Example Content Streaming System

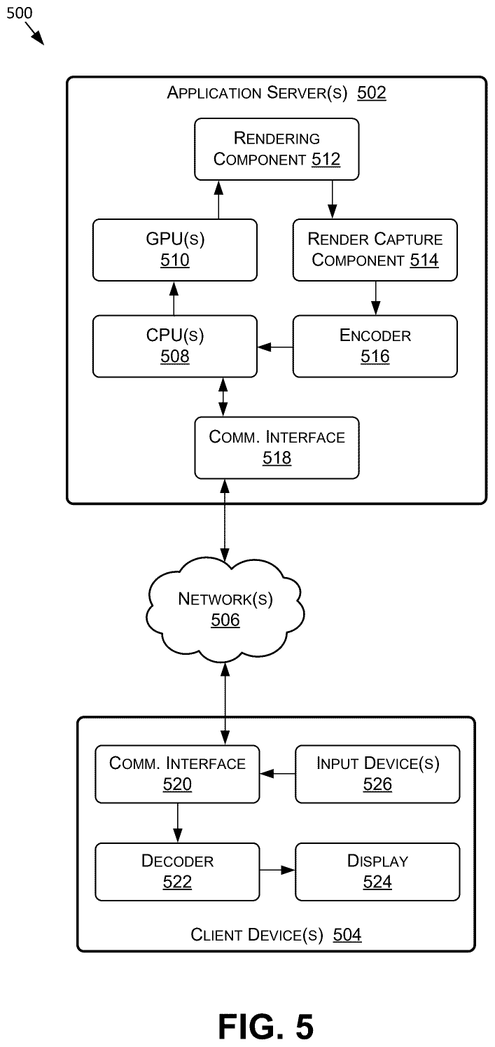

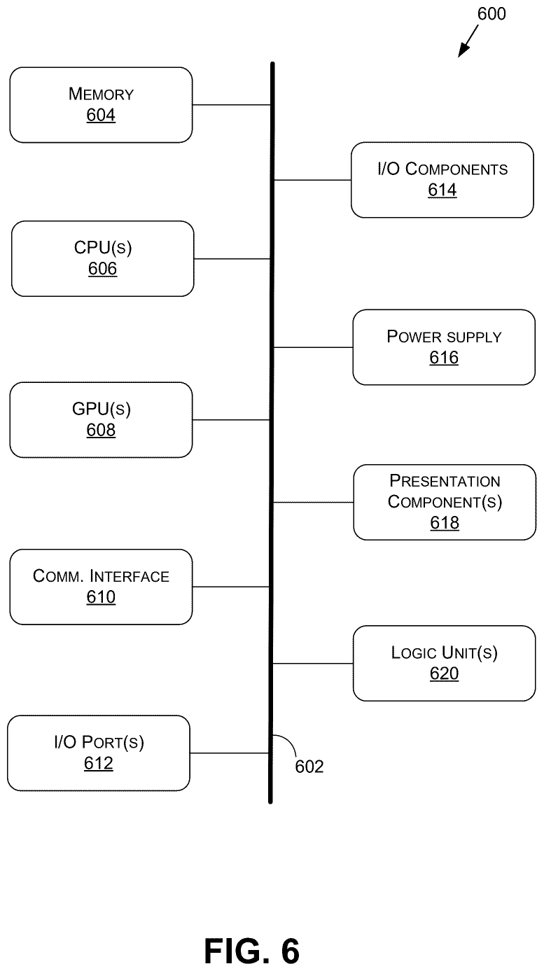

Now referring to FIG. 5, is an example system diagram for a content streaming system 500, in accordance with some implementations of the present disclosure. FIG. 5 includes application server(s) 502 (which may include similar components, features, and/or functionality to the example computing device 600 of FIG. 6), client device(s) 504 (which may include similar components, features, and/or functionality to the example computing device 600 of FIG. 6), and network(s) 506 (which may be similar to the network(s) described herein). The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 500 can be implemented to receive input indicating one or more features of output to be generated using a neural network model, provide the input to the model to cause the model to generate the output, and use the output for various operations including display or simulation operations.

In the system 500, for an application session, the client device(s) 504 may only receive input data in response to inputs to the input device(s) 526, transmit the input data to the application server(s) 502, receive encoded display data from the application server(s) 502, and display the display data on the display 524. As such, the more computationally intense computing and processing is offloaded to the application server(s) 502 (e.g., rendering—in particular ray or path tracing—for graphical output of the application session is executed by the GPU(s) of the application server(s) 502). In other words, the application session is streamed to the client device(s) 504 from the application server(s) 502, thereby reducing the requirements of the client device(s) 504 for graphics processing and rendering.

For example, with respect to an instantiation of an application session, a client device 504 may be displaying a frame of the application session on the display 524 based at least on receiving the display data from the application server(s) 502. The client device 504 may receive an input to one of the input device(s) 526 and generate input data in response. The client device 504 may transmit the input data to the application server(s) 502 via the communication interface 520 and over the network(s) 506 (e.g., the Internet), and the application server(s) 502 may receive the input data via the communication interface 518. The CPU(s) 508 may receive the input data, process the input data, and transmit data to the GPU(s) 510 that causes the GPU(s) 510 to generate a rendering of the application session. For example, the input data may be representative of a movement of a character of the user in a game session of a game application, firing a weapon, reloading, passing a ball, turning on a vehicle, etc. The rendering component 512 may render the application session (e.g., representative of the result of the input data) and the render capture component 514 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 502. In some implementations, one or more virtual machines (VMs)—e.g., including one or more virtual components, such as vGPUs, vCPUs, etc.—may be used by the application server(s) 502 to support the application sessions. The encoder 516 may then encode the display data to generate encoded display data and the encoded display data may be transmitted to the client device 504 over the network(s) 506 via the communication interface 518. The client device 504 may receive the encoded display data via the communication interface 520 and the decoder 522 may decode the encoded display data to generate the display data. The client device 504 may then display the display data via the display 524.

### Example Computing Device

FIG. 6 is a block diagram of an example computing device(s) 600 suitable for use in implementing some implementations of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one implementation, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some implementations, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may be arranged in various topologies, including but not limited to bus, star, ring, mesh, tree, or hybrid topologies. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In implementations, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU 608 may include its own memory or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In implementations, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In implementations, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, including wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 620 and/or communication interface 610 may include one or more data processing units (DPUs) to transmit data received over a network and/or through interconnect system 602 directly to (e.g., a memory of) one or more GPU(s) 608. In some implementations, a plurality of computing devices 600 or components thereof, which may be similar or different to one another in various respects, can be communicatively coupled to transmit and receive data for performing various operations described herein, such as to facilitate latency reduction.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some implementations, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

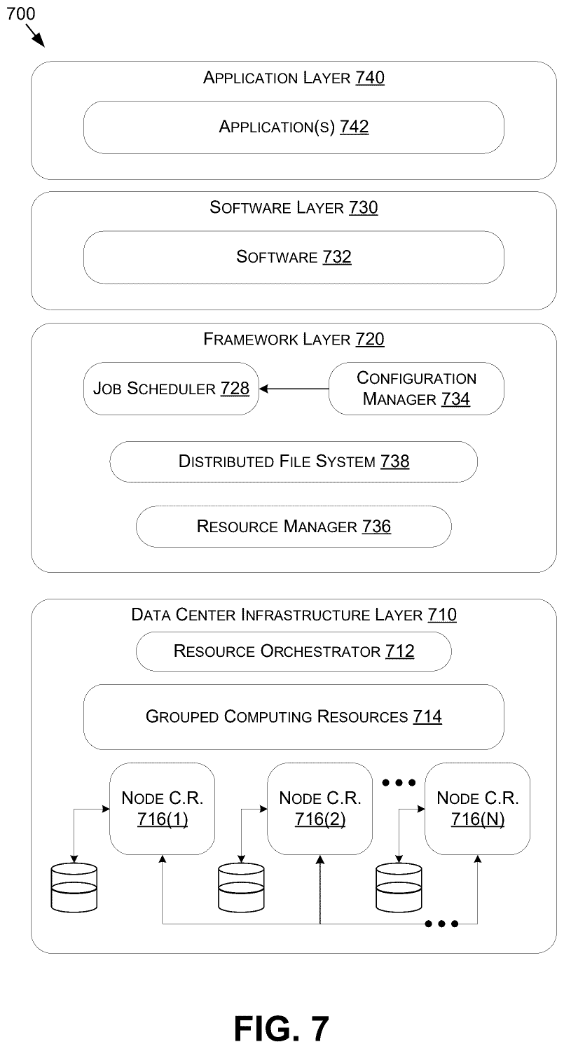

FIG. 7 illustrates an example data center 700 that may be used in at least one implementations of the present disclosure, such as to implement the systems 100, 200, or in one or more examples of the data center 700. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one implementation, node C.R. s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 716(1)-716(N) may correspond to a server having one or more of the above-mentioned computing resources. In addition, in some implementations, the node C.R.s 716(1)-716(N) may include one or more virtual components, such as vGPUs, vCPUs, and/or the like, and/or one or more of the node C.R. s 716(1)-716(N) may correspond to a virtual machine (VM).

In at least one implementation, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one implementation, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one implementation, resource orchestrator 712 may include a software design infrastructure (SDI) management entity for the data center 700. The resource orchestrator 712 may include hardware, software, or some combination thereof.

In at least one implementation, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one implementation, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one implementation, clustered or grouped computing resources may include grouped computing resource 714 at data center infrastructure layer 710. The resource manager 736 may coordinate with resource orchestrator 712 to manage these mapped or allocated computing resources.

In at least one implementation, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one implementation, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine-learning application, including training or inferencing software, machine-learning framework software (e.g., PyTorch, TensorFlow, Caffe, etc.), and/or other machine-learning applications used in conjunction with one or more implementations, such as to train/update and/or execute machine-learning models.

In at least one implementation, any of configuration manager 734, resource manager 736, and resource orchestrator 712 may implement any number and type of self-modifying actions based at least on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to update/train one or more machine-learning models or predict or infer information using one or more machine-learning models according to one or more implementations described herein. For example, a machine-learning model(s) may be updated/trained by calculating weight parameters according to a neural network architecture using software and/or computing resources described above with respect to the data center 700. In at least one implementation, trained or deployed machine-learning models corresponding to one or more neural networks may be used to infer or predict information using resources described above with respect to the data center 700 by using weight parameters calculated through one or more training techniques, such as but not limited to those described herein.

In at least one implementation, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to update/train or perform inferencing of information, such as image recognition, speech recognition, or other artificial intelligence services.

### Example Network Environments

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment - and one or more client-server network environments—in which case one or more servers may be included in a network environment. In peer-to-peer network environments, functionality described herein with respect to a server(s) may be implemented on any number of client devices.

In at least one implementation, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is

1. One or more processors comprising:
one more circuits to:
detect, using a guest operating system (OS) of a virtual machine (VM), a condition of a workload of the VM being executed on processing units including a central processing unit (CPU) and a graphics processing unit (GPU), the condition indicative of operation of one of the processing units being different than a target level of operation, the target level based on at least one of (i) a characteristic of the workload or (ii) operation of another of the processing units;
provide, to a host OS, based at least on the condition, an instruction to reduce operation of the one of the processing units; and
modify, by the host OS, behavior of the processing units based on the instruction.

2. The one or more processors of claim 1, wherein the one or more circuits are to execute the VM, and wherein the VM is configured to cause the CPU and the GPU to execute the workload.

3. The one or more processors of claim 1, wherein the one or more circuits are to detect the condition based at least on one of: i) a load of the GPU, ii) an occupancy of a queue of the GPU, or iii) a resolution characteristic.

4. The one or more processors of claim 1, wherein the one or more circuits are to communicate the instruction to the host OS using a channel from a guest OS to the host OS.

5. The one or more processors of claim 1, wherein one or more characteristics of the workload used to detect the condition are not provided to the host OS.

6. The one or more processors of claim 1, wherein the one or more circuits are to detect the condition by evaluating a characteristic of at least one of the workload, the operation of the CPU, or the operation of the GPU, using one or more rules, policies, or heuristics.

7. The one or more processors of claim 1, wherein the workload is a real-time workload of the VM.

8. The one or more processors of claim 1, wherein the one or more processors are comprised in at least one of:
a system incorporating one or more VMs;
a system for performing simulation operations;
a system for performing light transport simulation;
a system implemented using an edge device;
a system implemented using a robot;
a system for performing collaborative content creation for 3D assets;
a system comprising one or more large language models (LLMs);
a control system for an autonomous or semi-autonomous machine;
a perception system for an autonomous or semi-autonomous machine;
a system for generating synthetic data;
a system for performing digital twin operations;
a system for performing conversational AI operations;
a system for performing deep learning operations;
a system implemented at least partially in a data center; or
a system implemented at least partially using cloud computing resources.

9. A system, comprising:
one or more processing units; and
one or more memory units storing instructions that, when executed by the one or more processing units, cause the one or more processing units to execute operations comprising:
detecting, using a guest operating system (OS) of a virtual machine (VM), a condition of a workload of the VM being executed on a central processing unit (CPU) and on a graphics processing unit (GPU) through the VM, the condition indicative of operation of one of the CPU or the GPU being different than a target level of operation, the target level based on at least one of (i) a characteristic of the workload or (ii) operation of the other of the CPU or the GPU;
providing, to a host OS, based at least on the condition, an instruction to reduce operation of the one of the CPU or the GPU; and
modifying, by the host OS, behavior of the one or more processing units based on the instruction.

10. The system of claim 9, wherein the operations further comprise executing the VM, and wherein the VM is configured to cause the CPU and the GPU to execute the workload.

11. The system of claim 9, wherein the operations further comprise detecting the condition based at least on one of: i) a load of the GPU, ii) an occupancy of a queue of the GPU, or iii) a resolution characteristic.

12. The system of claim 9, wherein operations further comprise communicating the instruction to the host OS using a channel from a guest OS to the host OS.

13. The system of claim 9, wherein one or more characteristics of the workload used to detect the condition are not provided to the host OS.

14. The system of claim 9, wherein operations further comprise detecting the condition by evaluating a characteristic of at least one of the workload, the operation of the CPU, or the operation of the GPU, using one or more rules, policies, or heuristics.

15. A method, comprising:
detecting, using a guest operating system (OS) of a virtual machine (VM), a condition of a workload of the VM being executed on processing units including a central processing unit (CPU) and on a graphics processing unit (GPU), the condition indicative of operation of one of the processing units being different than a target level of operation, the target level based on at least one of (i) a characteristic of the workload or (ii) operation of another of the processing units;
providing, to a host OS, based at least on the condition, an instruction to reduce operation of the one of the processing units; and
modifying, by the host OS, behavior of the processing units based on the instruction.

16. The method of claim 15, further comprising executing the VM, and wherein the VM is configured to cause the CPU and the GPU to execute the workload.

17. The method of claim 15, further comprising detecting the condition based at least on one of: i) a load of the GPU, ii) an occupancy of a queue of the GPU, or iii) a resolution characteristic.

18. The method of claim 15, further comprising communicating the instruction to the host OS using a channel from a guest OS to the host OS.

19. The method of claim 15, wherein one or more characteristics of the workload used to detect the condition are not provided to the host OS.

20. The method of claim 15, further comprising detecting the condition by evaluating a characteristic of at least one of the workload, the operation of the CPU, or the operation of the GPU, using one or more rules, policies, or heuristics.
